(19) United States
(12) Patent Application Publication
(10) Pub. No.: US 2023/0293372 A1
(43) Pub. Date: Sep. 21, 2023

(54) Self-Righting Portable Urinal Container

(71) Applicants: Bernard F. Pettingill, JR., Palm Beach Gardens, FL (US); Lawrence Chandler, Bradenton, FL (US); Gerald S. George, Lafayette, LA (US)

(72) Inventors: Bernard F. Pettingill, JR., Palm Beach Gardens, FL (US); Lawrence Chandler, Bradenton, FL (US); Gerald S. George, Lafayette, LA (US)

(21) Appl. No.: 18/200,398

(22) Filed: May 22, 2023

(51) Int. Cl. A61G 9/00

(52) U.S. Cl. CPC A61G 9/006

(57) ABSTRACT

A self-righting portable urinal container includes a housing, a semispherical drip lip, a screw top and loop handles. The housing defines an inner space and has a round open top opposite a base. The base is either rounded or planar (flat base). The round open top has an internally threaded neck at an offset to the housing and the base has a weighted ballast. The semispherical drip lip surrounds at least a portion of portion of the round open top or the threaded neck. The semispherical drip lip forms a urinal receptacle. The screw top has a top handle and a threaded bottom. The threaded bottom includes a seal. The threaded bottom is removably connected to the internally threaded neck of the round open top. The first loop handle is fixed to a first outer portion of a continuous wall of the housing.

### BACKGROUND OF THE INVENTION

### Field of the Invention

The present disclosure generally relates to a portable urinal container and, more particularly, relates to portable urinal containers that mitigate spillage and include an increased surface for receiving urine.

### Description of the Related Art

Portable urinals are used for collecting urine of a user in a container such as a bottles, urinals, bedpans, or chamber pots. These urinal containers are very useful in a scenario where normal/fixed urinals are not available or within the reach of the user. The portable urinal containers have been of great use for patients either in hospitals or at home.

The hospitals are generally crowded and things are done in haste, and thus have the tendency to knock out objects on the floor. It is observed that the portable urinal containers have tendency to get knockout which results in embarrassment to the patients and also creates a mess.

Various types of portable urinals are available for the users in the market. These urinals have their own unique shapes for collecting urine. Further, the portable urinals are designed to provide comfort to the users during use. Most of the available portable urinals provide a narrow opening for receiving urine of the user, which mostly results in spilling on to the floor/clothes and causing hygiene issues.

Most of the portable urinals available in the market are made of light weight material or are made of metals. Metal urinals are complex to use as they tend to be noisy and have higher splash rate. Rubber or plastic made portable urinals are light weighted but have the tendency to falls over and spills.

Therefore, a need exists for a self-righting portable urinal container. Further, the self-righting portable urinal container should have a top with an increased surface area to avoid spilling of urine. Furthermore, the self-righting portable urinal container should have a weighted ballast to prevent swaying.

A need exists for a self-righting urinal container capable of universal application. Accordingly, there is a need for a self-righting urinal container, that may be easily positioned and/or repositioned at the option and intention of the user without complex assembly and setup.

As disclosed in this application, the inventor has discovered novel and unique devices and methods for decorating with door wreaths, which exhibit superlative properties without being dependent on heavy, immobile, components.

The devices disclosed herein avoid many of the drawbacks of existing devices which rely on expensive complexities or complex tools for application of the devices to the door.

Embodiments of the present invention provide for decorative door wreaths as described and defined in the description below and in the annexed claims which provide for improved mobility, setup, and retention characteristics in order to efficiently interchange decorative ornaments of various sizes of interest in a multitude of environments.

### SUMMARY OF THE INVENTION

It is one prospect of the present invention to provide a novel self-righting urinal container of simple but effective construction which can be utilized by users of different sizes and shapes.

In one embodiment, an improved self-righting portable urinal container is provided having a housing, a semispherical drip lip, a screw top and at least a first loop handle.

The housing defines an inner space. The housing includes a round open top opposite a rounded base and a continuous wall disposed between the round open top and the rounded base. The round open top is sized and configured to receive a penis of a user. The continuous wall includes at least one transparent portion adapted for visualization of a level of urine received into and contained within the housing. The round open top includes an internally threaded neck. The rounded base includes a weighted ballast.

In a preferred embodiment, the semispherical drip lip surrounds at least a portion of portion of the round open top. The semispherical drip forms a urinal receptacle. The screw top includes a top handle and a threaded bottom. The threaded bottom includes a seal. The threaded bottom is removably connected to the internally threaded neck of the round open top. The first loop handle is fixed to a first outer portion of the continuous wall.

In one embodiment, the self-righting portable urinal container includes a retainer cord and an elongated retention rod. The retainer cord has a proximal end opposite a distal end. The proximal end is fixed to a bottom surface of the screw top. The elongated retention rod is attached preferably perpendicular to the distal end of the retainer cord. The elongated retention rod is disposed in the inner space of the housing. The elongated retention rod has a greater axial length than a diameter of the round open top of the housing, which helps to prevent the elongated retention rod from passing through the round open top of the housing.

In another embodiment, the round open top and the rounded base define a common imaginary vertical axis, and the housing preferably includes a pear-shaped configuration relative to the common imaginary vertical axis.

In a preferred embodiment, the self-righting portable urinal container includes at least a second loop handle fixed to a second outer portion of the continuous wall. The second outer portion is preferably disposed on an opposite side of the housing than the first outer portion.

Yet another object of the present invention is to provide the round open top with a diameter ranging between 1.25 inches to 1.50 inches. The inner space of the housing comprises a volume of at least 90 fluid ounces.

In a preferred embodiment, the housing of the self-righting portable urinal container has a planar base and a continuous wall defining at least a first hand aperture and at least a second hand aperture. The at least first hand aperture and the at least second hand aperture are sized and configured to receive at least a portion of a hand of a user. The continuous wall comprises edges continuously fixed to portions of an inner surface of the continuous wall at the at least first hand aperture and at the at least second hand aperture. The first hand aperture and the second hand aperture each form a handle adapted to receive the at least a portion of the hand of the user.

As further disclosed herein, there is provided a self-righting portable urinal container having a housing defining an inner space, where the housing has a flat bottom and a continuous outer wall extending upwardly from the flat bottom. The continuous outer wall comprises at least one transparent portion adapted for visualization of a level of urine received into and contained within the housing. In one embodiment, the housing comprises an internally threaded neck configured to form an offset with the extended continuous outer wall. The internally threaded neck is sized and configured to receive a penis of a user.

Preferably, the internally threaded neck includes a first neck portion diagonally extending from the continuous outer wall. The internally threaded neck also includes a second neck portion extended upwardly from the first neck portion.

In a preferred embodiment, the self-righting portable urinal container has a semispherical drip lip surrounding at least a portion of the internally threaded neck, where the semispherical drip lip forms a urinal receptacle.

In one embodiment, the self-righting portable urinal container comprises a screw top having a top handle and a threaded bottom. The threaded bottom includes a seal, and the threaded bottom is removably connected to the internally threaded neck. In a preferred embodiment, the self-righting portable urinal container comprises at least a first loop handle that is fixed to a first outer portion of the continuous wall, where the at least first loop handle is positioned on an angle that departs from a vertical axis of the housing of the self-righting portable urinal container.

Additional objects, advantages and novel features of this invention shall be set forth in the description that follows, and in part will become apparent to those skilled in the art upon examination of the following specification and claims of my invention. The objects and advantages of the invention may be realized and attained by means of the instrumentalities, combinations, and devices particularly pointed out in the appended claims.

The following presents a simplified summary of the present disclosure in a simplified form as a prelude to the more detailed description that is presented herein.

Therefore, to achieve the foregoing and other objects and in accordance with the purposes and embodiments of the present invention, there is provided self-righting urinal container devices as further embodied and described herein.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 is a front view of a self-righting portable urinal container, in accordance with embodiments of the invention;

FIG. 2 is a front view of a self-righting portable urinal container, in accordance with embodiments of the invention;

FIG. 3 is a schematic view of the self-righting portable urinal container showcasing self-righting phenomenon, in accordance with embodiments of the invention;

FIG. 4 is another schematic view of the self-righting portable urinal container showcasing the disclosed self-righting phenomenon from multiple positions, in accordance with embodiments of the invention;

FIG. 5 is a side view of a self-righting portable urinal container, in accordance with embodiments of the invention;

FIG. 6 is a front view of the self-righting portable urinal container, in accordance with other embodiments of the invention;

FIG. 7 is a front view of the self-righting portable urinal container, in accordance with other embodiments of the invention; and

FIG. 8 a perspective view of another self-righting portable urinal container, in accordance with other embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

For purposes of clarity and orientation with respect to a person, referred to herein as a user, it is noted that a transverse (also known as axial or horizontal) plane is an X-Z plane, parallel to the ground. A frontal (also known as coronal) plane is a Y-X plane, perpendicular to the ground, which separates the anterior from the posterior, the front from the back. A sagittal (also known as lateral) plane is an Y-Z plane, perpendicular to the ground, which separates left from right. Objects are coplanar if they all lie in the same plane. For example, one axis is coplanar with another axis when the two axes lie in the same plane.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, and coatings.

Reference will now be made in detail to the present preferred embodiments of the invention, examples of which are illustrated in the accompanying drawings. Wherever possible, the same reference numerals are used in the drawings and the description to refer to the same or like parts.

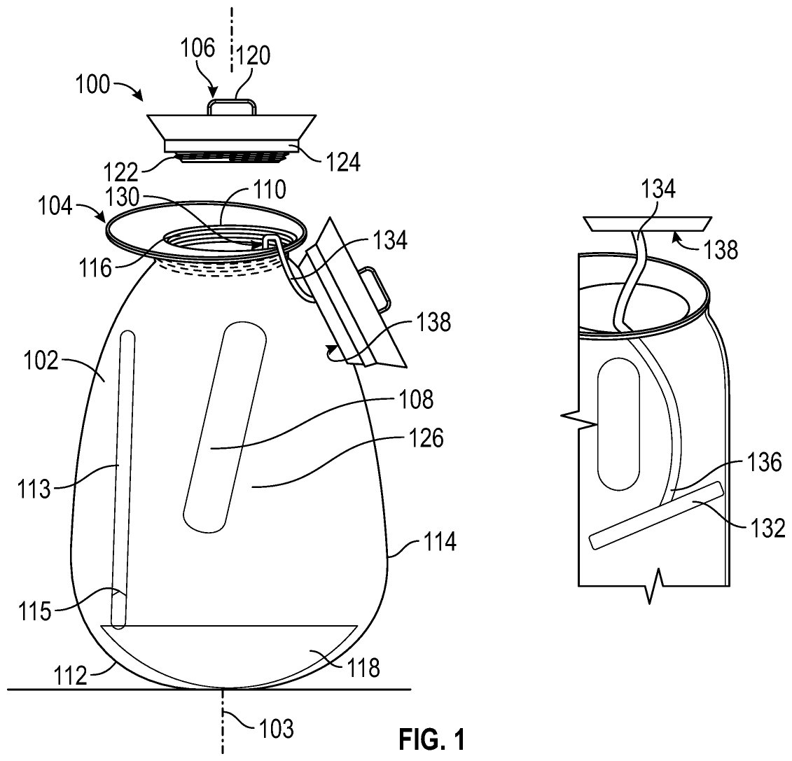

Referring initially to FIGS. 1 to 4, a self-righting portable urinal container 100 is disclosed. FIG. 1 is a front view of the self-righting portable urinal container 100. In one embodiment, the self-righting portable urinal container 100 includes a housing 102, a semispherical drip lip 104, a screw top 106 and at least a first loop handle 108, as illustrated in FIG. 1. The housing 102 defines an inner space. In one embodiment, the inner space refers to a hollow space inside of the housing 102 to receive urine.

The housing 102 comprises a round open top 110 opposite a semi-rounded base 112 and a continuous outer wall 114 disposed between the round open top 110 and the semi-rounded base 112. The round open top 110 is sized and configured to receive a penis of a user. The continuous outer wall 114 includes at least one transparent portion 113 adapted for visualization of a level 115 of urine received into and contained within the housing 102.

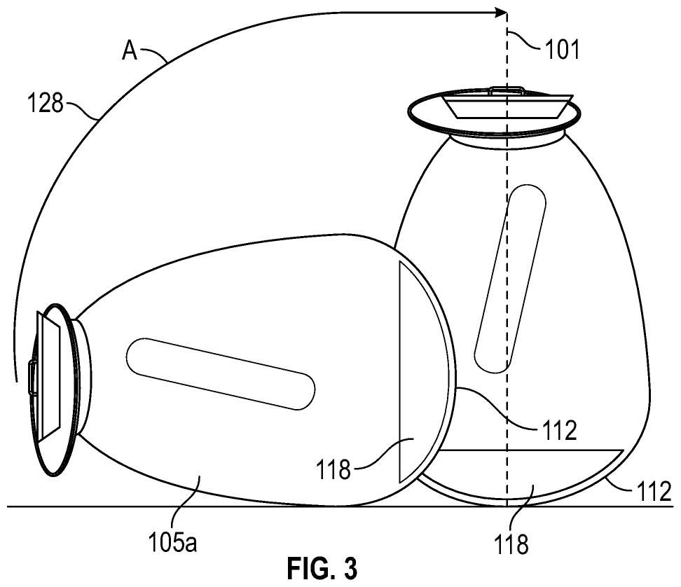

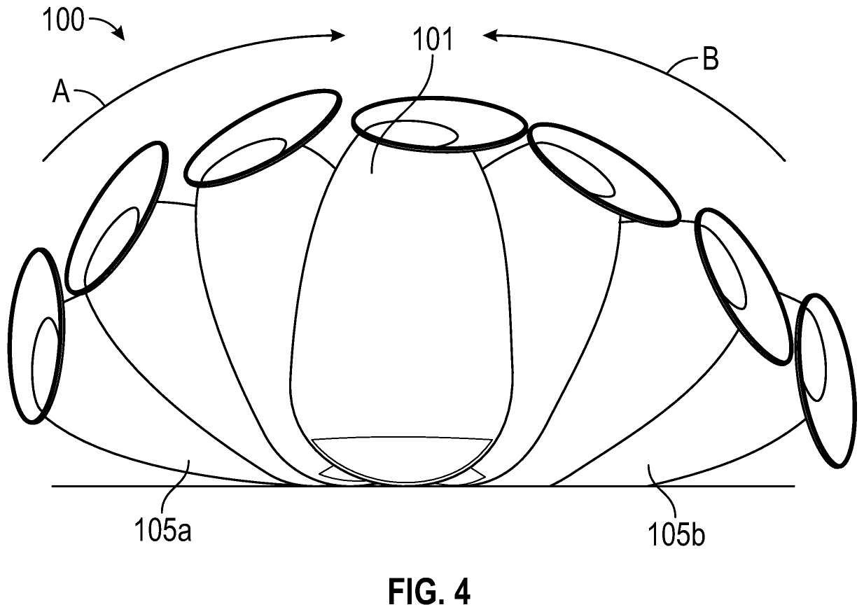

In one embodiment, the round open top 110 comprises an internally threaded neck 116, as illustrated in FIG. 1. The rounded base 112 comprises a weighted ballast 118, which self-rights the self-righting portable urinal container 100 (in the direction of Arrow A and Arrow B) to a vertically upright position 101, as exemplified in FIGS. 3-4.

As shown in FIG. 1, the screw top 106 includes a top handle 120 and a threaded bottom 122. The threaded bottom 122 preferably includes a seal 124. The threaded bottom 122 is removably connected to the internally threaded neck 116 of the round open top 110. The first loop handle 108 is fixed to a first outer portion 126 of the continuous outer wall 114.

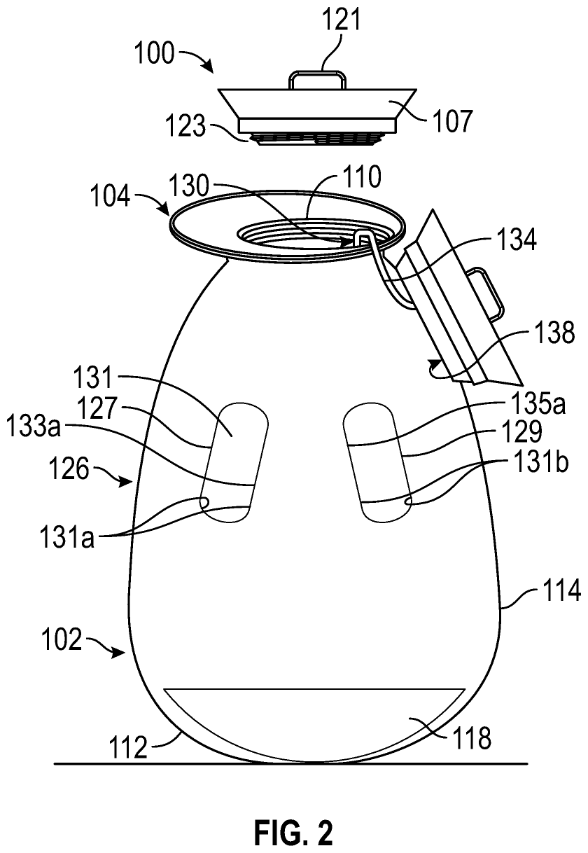

In another embodiment, as illustrated in FIG. 2, the self-righting portable urinal container 100 includes a housing 102, a semispherical drip lip 104, and a top 107 having a rubber pressure seal 123 that is activated by a spring-loaded button 121. In such embodiment, the round open top 110 receives the rubber pressure seal 123 of the top 107, and the rubber pressure seal 123 expands into a fitting engagement of the round open top 110 when the spring-loaded button 121 is activated. In other words, the expansion of the rubber pressure seal 123 causes the round open top 110 to be sealed shut when the top 107 is fitted inside the round open top 110 and the spring-loaded button 121 is activated by being pressed by the user. In one embodiment, the rubber pressure seal 123 is pneumatically pressurized by the spring-loaded button 121.

As shown in FIG. 2, the continuous outer wall 114 defines at least a first hand aperture 127 and at least a second hand aperture 129. The at least first hand aperture 127 and the at least second hand aperture 129 are sized and configured to receive at least a portion of a hand of a user. As illustrated in FIG. 2, the self-righting portable urinal container 100 includes a continuous inner wall 131. The continuous inner wall 131 has edges 131a, 131b continuously fixed to respective portions 133a, 135a of an inner surface of the continuous outer wall 114 at the first hand aperture 127 and at the second hand aperture 129, respectively.

In a preferred embodiment, the semispherical drip lip 104 surrounds at least a portion of the round open top 110, as exemplified in FIGS. 1-4. The semispherical drip lip 104 forms a urinal receptacle that helps a user to urinate into the portable self-righting urinal container 100 without spillage.

Referring to FIGS. 1-4, in one exemplary embodiment, the weighted ballast 118 is preferably 5.00 LBS by weight. As illustrated in FIGS. 3-4, the semi-rounded base 112 is a semi-rounded bottom that makes the housing 102 untippable, which means that the housing 102 uprights itself (in the direction of either Arrow A or Arrow b, respectively) from an angled position (e.g., 105a, 105b) to a vertically upright position 101.

Referring to FIG. 1, in one embodiment, the first loop handles 108 are ergonomically tilted, on an angle that departs from a vertical axis 103 of the housing 102. Preferably, the inner space of the housing 102 is able to store or collect up to ½ Gallon or 4.25 LBS by weight or 90 fluid ounces. The housing 102 is preferably fabricated with a medical-grade plastic.

In one exemplary embodiment, the seal 124 is made up of a graduated rubber, and the round open top 110 preferably has a diameter length between 1.25 inches to 2.50 inches.

It would be readily apparent to those skilled in the art that various material & size of the housing 102, the drip lip 104, the screw top 106 and the loop handle 108 may be envisioned without deviating from the scope of the present invention.

Referring to FIGS. 1-2, in one embodiment, the self-righting portable urinal container 100 includes a retainer cord 130 and an elongated retention rod 132. The retainer cord 130 has a proximal end 134 opposite a distal end 136. The proximal end 134 is fixed to a bottom surface 138 of the screw top 106. The elongated retention rod 132 is attached perpendicularly to the distal end 134 of the retainer cord 130, and the elongated retention rod 132 is disposed in the inner space of the housing 102, as shown in FIG. 1. The elongated retention rod 132 preferably has an axial length which is greater in length than a diameter of the round open top 110.

In one embodiment, the round open top 110 and the rounded base 112 defines a common imaginary vertical axis. The housing 102 is configured as a pear-shaped configuration relative to the common imaginary vertical axis. It would be readily apparent to those skilled in the art that various shapes of the housing 102 may be envisioned to attain self-righting property, without deviating from the scope of the present invention.

In one embodiment, the self-righting portable urinal container 100 further includes at least a second loop handle (not shown in FIG. 1) fixed to a second outer portion of the continuous outer wall 114. The second outer portion is disposed on an opposite side of the housing 102 than the first outer portion 126.

FIG. 3 is a schematic view of the self-righting portable urinal container 100 showcasing the self-righting phenomenon. The rounded base 112 and the weighted ballast 118 are configured to make the housing 102 untippable. The Arrow A indicates the self-righting phenomenon of the housing 102 from a tilted position (e.g., 105a, 105b) to an original upright position 101.

FIG. 4 provides another schematic view of the self-righting portable urinal container 100 showcasing the self-righting phenomenon of the self-righting portable urinal container 100 from multiple positions, in accordance with embodiments of the invention. The self-righting portable urinal container 100 is able to return to the original upright position from various tilted positions (e.g., 105a, 105b). As seen in FIGS. 3-4, the self-righting portable urinal container 100 has the phenomenon of getting back to the original upright position 101 after getting knocked over to various tilted positions (e.g., 105a, 105b).

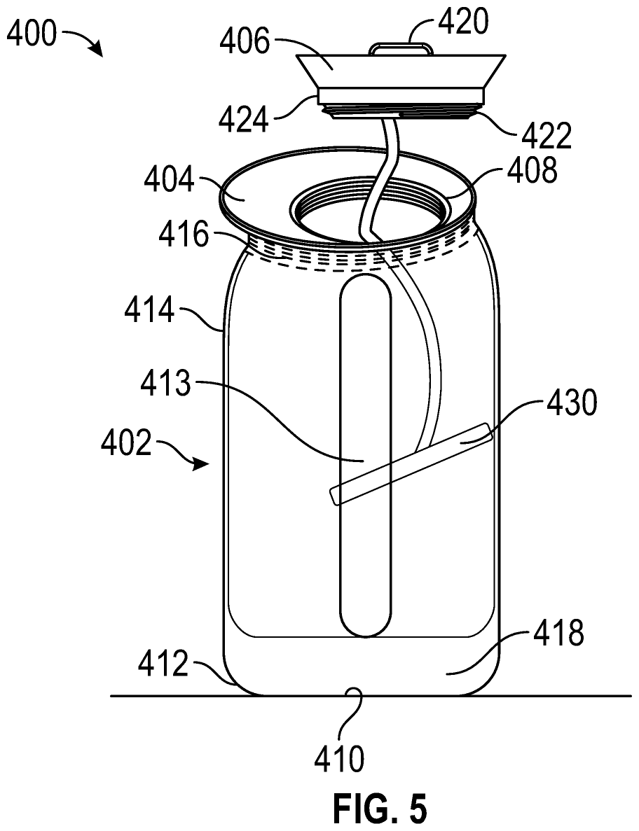

Referring to FIG. 5, in accordance with other embodiments of the disclosed invention, a self-righting portable urinal container 400 is disclosed having a housing 402, a semispherical drip lip 404, and a screw top 406. The housing 402 defines an inner space. The housing 402 includes a round open top 408 opposite a planar base 410 comprises a rounded peripheral edge 412. The housing 402 is having a continuous outer wall 414 disposed between the round open top 408 and the rounded peripheral edge 412 of the planar base 410.

The round open top 408 is sized and configured to receive a penis of a user. The continuous wall 414 has a transparent portion 413 adapted for visualization of a level of urine received into and contained within the housing 402. The round open top 408 includes an internally threaded neck 416. The planar base 410 includes a weighted ballast 418.

The semispherical drip lip 404 surrounds at least a portion of the round open top 408. The semispherical drip lip 404 forms a urinal receptacle. The functionality and shape of the semispherical drip lip 404 is similar to the semispherical drip lip 104, and as shown and explained in detail in conjunction with FIG. 1 of the present invention.

Referring to FIG. 5, the screw top 406 has a top handle 420 and a threaded bottom 422. The threaded bottom 422 includes a seal 424. The threaded bottom 422 removably connected to the internally threaded neck 416 of the round open top 408. The functionality and shape of the screw top 406 is similar to the screw top 106, and as shown and explained in detail in conjunction with FIG. 1 of the present invention.

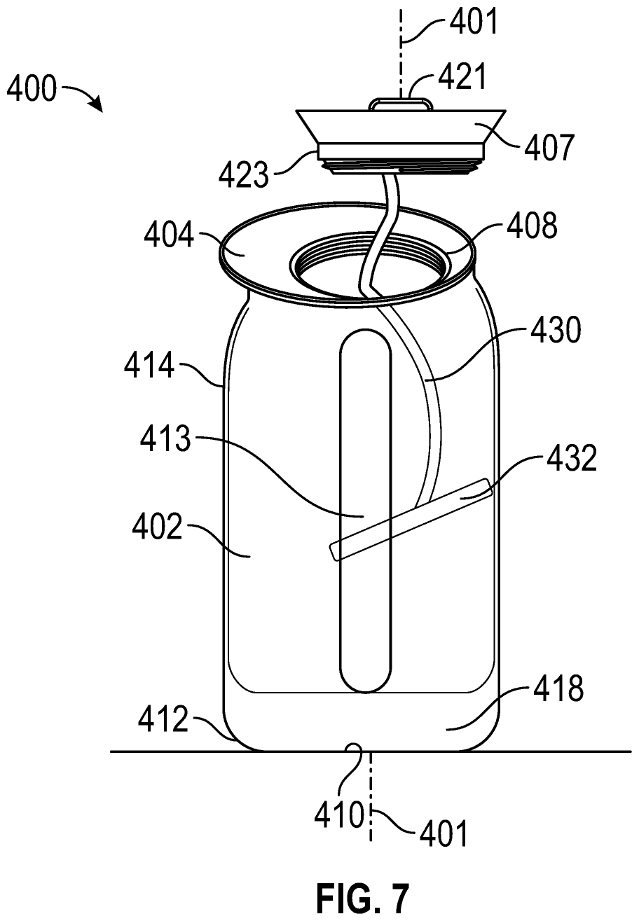

In another embodiment, as illustrated in FIG. 7, the self-righting portable urinal container 100 includes a housing 402, a semispherical drip lip 404, and a top 407 having a rubber pressure seal 423 that is activated by a spring-loaded button 421. In such embodiment, the round open top 408 receives the rubber pressure seal 423 of the top 407, and the rubber pressure seal 423 expands into a fitting engagement of the round open top 408 when the spring-loaded button 421 is activated. In other words, the expansion of the rubber pressure seal 423 causes the round open top 408 to be sealed shut when the top 407 is fitted inside the round open top 408 and the spring-loaded button 421 is activated by being pressed by the user. In one embodiment, the rubber pressure seal 423 is pneumatically pressurized by the spring-loaded button 421.

In one embodiment, the self-righting portable urinal container 400 further includes a retainer cord 430 attached to a retention rod 432. The retainer cord 430 has a proximal end opposite a distal end. The proximal end is fixed to a bottom surface of the top 407. The functionality and shape of the retainer cord 430 is same as the retainer cord 132, and as shown and explained in detail in conjunction with FIG. 1 of the present invention.

The round open top 408 and the planar base 410 define a common imaginary vertical axis 401. The housing 402 includes a substantially cylindrical-shaped configuration relative to the common imaginary vertical axis. The housing 402 includes a substantially cylindrical-shaped configuration relative to the common imaginary vertical axis.

The round open top 408 includes a diameter in range of 1.25 inches to 1.50 inches. The inner space of the housing 402 is configured to store or collect ½ Gallon or 4.25 LBS by weight or 90 fluid ounces. It would be readily apparent to those skilled in the art that various type of material may be envisioned to create housing 402 without deviating from the scope of the present invention.

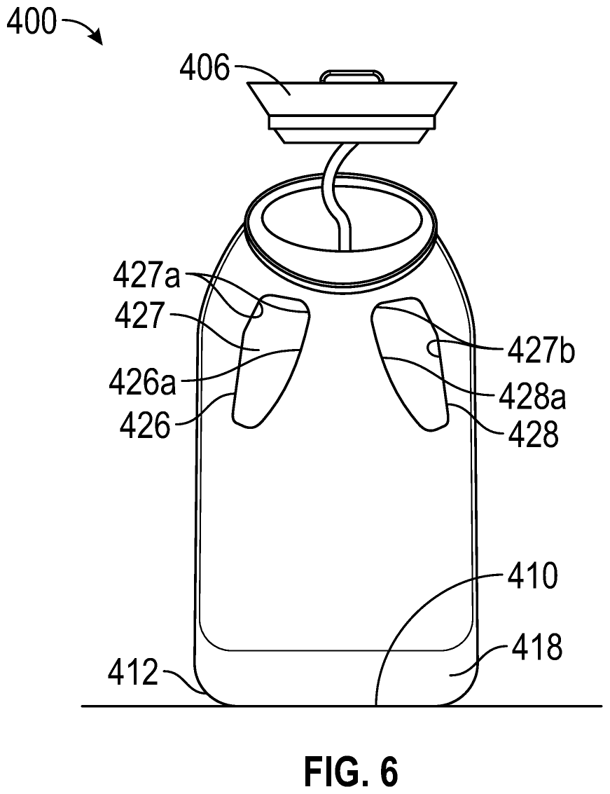

FIG. 6 is a front view of the self-righting portable urinal container 400, in accordance with another embodiment of the invention. The continuous outer wall 414 defines at least a first hand aperture 426 and at least a second hand aperture 428. The at least first hand aperture 426 and the at least second hand aperture 428 are sized and configured to receive at least a portion of a hand of a user.

As illustrated in FIG. 6, the self-righting portable urinal container 400 includes a continuous inner wall 427. The continuous inner wall 427 has edges 427a, 427b continuously fixed to respective portions 426a, 428a of an inner surface of the continuous outer wall 414 at the first hand aperture 426 and at the second hand aperture 428, respectively. The at least first hand aperture 426 and the at least second hand aperture 428 form a handle adapted to receive at least a portion of the hand of the user.

The present invention allows a user to urinate into the portable self-righting urinal container 100, 400, without spillage. The disclosed self-righting containers 100, 400 are able to respectively retain an original upright position from a knocked down position. Further, the self-righting containers allow a user to urinate inside the housing without dripping, due to the respective drip lip 104, 404.

Product information and promotional information is preferably applied to the housing 102, 402, as tailored to the user's desired marketing strategies. Advertising with the self-righting portable urinal container 100, 400 provides mechanisms to promote specific marketing initiatives, including promoting various hospital related services and medicines.

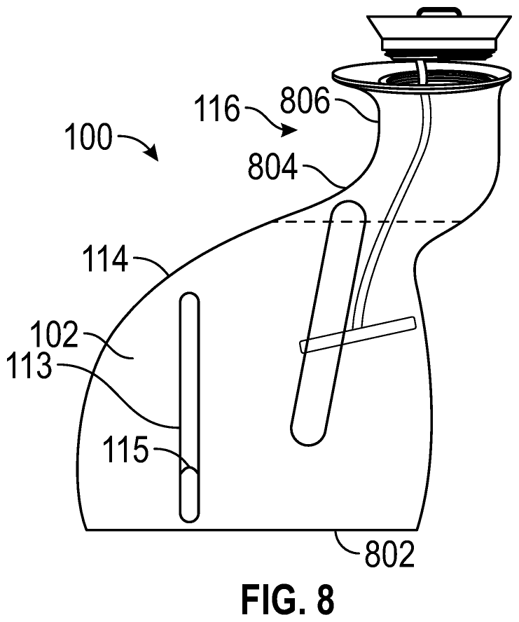

As illustrated in FIG. 8, there is provided a self-righting portable urinal container 100 having a housing 102 defining an inner space. The housing 102 has a flat bottom 802 and a continuous outer wall 114 extending upwardly from the flat bottom 802. The continuous outer wall 114 has at least one transparent portion 113 adapted for visualization of a level 115 of urine received into and contained within the housing 102 of the self-righting portable urinal container 100.

Referring to FIG. 8, the housing 102 has an internally threaded neck 116 configured to form an offset with the extended continuous outer wall 114. The internally threaded neck 116 is sized and configured to receive a penis of a user.

As illustrated in FIG. 8, the internally threaded neck 116 includes a first neck portion 804 diagonally extending from the continuous outer wall 114. The internally threaded neck 116 also includes a second neck portion 806 extended upwardly from the first neck portion 804.

In a preferred embodiment, the self-righting portable urinal container 100 has a semispherical drip lip (shown in FIGS. 1-7) surrounding at least a portion of the internally threaded neck 116, where the semispherical drip lip forms a urinal receptacle, for the embodiment shown in FIG. 8.

Referring to FIG. 8, the self-righting portable urinal container 100 has a screw top (106, shown in FIGS. 1-7) having a top handle and a threaded bottom. The threaded bottom includes a seal, and the threaded bottom is removably connected to the internally threaded neck.

In a preferred embodiment, the self-righting portable urinal container has at least a first loop handle (108, shown in FIGS. 1-7) that is fixed to a first outer portion of the continuous wall, where the at least first loop handle is positioned on an angle that departs from a vertical axis of the housing of the self-righting portable urinal container.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

The drawings and the forgoing description give examples of embodiments. Those skilled in the art will appreciate that one or more of the described elements may be very well combined into a single functional element. Alternatively, certain elements may be split into multiple functional elements. Elements from one embodiment may be added to another embodiment. For example, the orders of the processes described herein may be changed and are not limited to the manner described herein. Moreover, the actions of any flow diagram need not be implemented in the order shown; nor do all of the acts necessarily need to be performed.

Also, those acts that are not dependent on other acts may be performed in parallel with the other acts. The scope of embodiments is by no means limited by these specific examples. The components of the system including the devices and related technologies mentioned above are collectively used to improve performance of the insulated cap device.

Numerous variations, whether explicitly given in the specification or not, such as differences in structure, dimension, and use of material, are possible. Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The claimed invention is:

1. A self-righting portable urinal container, comprising:
a housing defining an inner space, said housing comprising a round open top opposite a semi-rounded base, said housing comprising a continuous outer wall disposed between the round open top and the semi-rounded base, the round open top sized and configured to receive a penis of a user, the continuous outer wall comprising at least one transparent portion adapted for visualization of a level of urine received into and contained within the housing, the round open top comprising an internally threaded neck, the semi-rounded base comprising a weighted ballast;
a semispherical drip lip surrounding at least a portion the round open top, said semispherical drip lip forming a urinal receptacle;
a screw top comprising a top handle and a threaded bottom, said threaded bottom comprising a seal, said threaded bottom removably connected to the internally threaded neck of the round open top; and
at least a first loop handle fixed to a first outer portion of the continuous wall, wherein said at least first loop handle is positioned on an angle that departs from a vertical axis of the housing.

2. The self-righting portable urinal container of claim 1, further comprising a retainer cord having a proximal end opposite a distal end, the proximal end fixed to a bottom surface of the screw top, the distal end attached perpendicular to an elongated retention rod, said elongated retention rod disposed in the inner space of the housing, said elongated retention rod having axial length that is greater in length than a diameter of the round open top.

3. The self-righting portable urinal container of claim 1, wherein said round open top and said semi-rounded base define a common imaginary vertical axis, wherein said housing comprises a pear-shaped configuration relative to said common imaginary vertical axis.

4. The self-righting portable urinal container of claim 1, further comprising at least a second loop handle fixed to a second outer portion of the continuous outer wall, wherein said second outer portion is disposed on an opposite side of the housing than the first outer portion.

5. The self-righting portable urinal container of claim 1, wherein said round open top comprises a diameter equal to 1.25 inches.

6. The self-righting portable urinal container of claim 1, wherein said round open top comprises a diameter equal to 1.50 inches.

7. The self-righting portable urinal container of claim 1, wherein said inner space of said housing comprises a volume of at least 90 fluid ounces.

8. The self-righting portable urinal container of claim 1, wherein said round open top comprises a diameter equal to 2.25 inches.

9. The self-righting portable urinal container of claim 1, wherein said round open top comprises a diameter equal to 2.50 inches.

10. A self-righting portable urinal container, comprising:
a housing defining an inner space, said housing comprising a round open top opposite a semi-rounded base, said housing comprising a continuous outer wall disposed between the round open top and the semi-rounded base, the round open top sized and configured to receive a penis of a user, the continuous outer wall comprising at least one transparent portion adapted for visualization of a level of urine received into and contained within the housing, the semi-rounded base comprising a weighted ballast;
the continuous outer wall defining at least a first hand aperture and at least a second hand aperture, the at least first hand aperture and the at least second hand aperture being sized and configured to receive at least a portion of a hand of a user;
a continuous inner wall comprising edges continuously fixed to respective portions of an inner surface of the continuous outer wall at the first hand aperture and at the second hand aperture, respectively;
a top comprising a spring-loaded button and a rubber pressure seal, wherein said rubber pressure seal is expanded upon a depression of the spring-loaded button, said expansion adapted to seal shut the round open top; and
a semispherical drip lip surrounding at least a portion the round open top, said semispherical drip lip forming a urinal receptacle.

11. The self-righting portable urinal container of claim 10, further comprising a retainer cord having a proximal end opposite a distal end, the proximal end fixed to a bottom surface of the top, the distal end attached perpendicular to an elongated retention rod, said elongated retention rod disposed in the inner space of the housing, said elongated retention rod having axial length that is greater in length than a diameter of the round open top.

12. The self-righting portable urinal container of claim 10, wherein said round open top and said rounded base define a common imaginary vertical axis, wherein said housing comprises a pear-shaped configuration relative to said common imaginary vertical axis.

13. The self-righting portable urinal container of claim 10, wherein said round open top comprises a diameter equal to 1.25 inches.

14. The self-righting portable urinal container of claim 10, wherein said round open top comprises a diameter equal to 1.50 inches.

15. The self-righting portable urinal container of claim 1, wherein said inner space of said housing comprises a volume of at least 90 fluid ounces.

16. The self-righting portable urinal container of claim 10, wherein said round open top comprises a diameter equal to 2.25 inches.

17. The self-righting portable urinal container of claim 10, wherein said round open top comprises a diameter equal to 2.50 inches.

18. A self-righting portable urinal container, comprising:
a housing defining an inner space, said housing having a round open top opposite a planar base having a rounded peripheral edge, said housing comprising a continuous wall disposed between the round open top and the rounded peripheral edge of the planar base, the round open top sized and configured to receive a penis of a user, the continuous wall comprising at least one transparent portion adapted for visualization of a level of urine received into and contained within the housing, the round open top comprising a, the planar base comprising a weighted ballast;
the continuous wall defining at least a first hand aperture and at least a second hand aperture, wherein said at least first hand aperture and said at least second hand aperture are sized and configured to receive at least a portion of a hand of a user;
a continuous inner wall having edges continuously fixed to portions of an inner surface of the continuous wall at said at least first hand aperture and at least second hand aperture, said at least first hand aperture and at least second hand aperture forming a handle adapted to receive the at least portion of the hand of the user;
a top comprising a spring-loaded button and a rubber pressure seal, wherein said rubber pressure seal is expanded upon a depression of the spring-loaded button, said expansion adapted to seal shut the round open top; and
a semispherical drip lip surrounding at least a portion of portion of the round open top, said semispherical drip lip forming a urinal receptacle.

19. The self-righting portable urinal container of claim 18, further comprising a retainer cord having a proximal end opposite a distal end, the proximal end fixed to a bottom surface of the screw top, the distal end comprising an elongated retention rod disposed perpendicular to said distal end, said elongated retention rod having axial length that is greater in length than a diameter of the round open top.

20. The self-righting portable urinal container of claim 18, wherein said round open top and said planar base define a common imaginary vertical axis, wherein said housing comprises a substantially cylindrical-shaped configuration relative to said common imaginary vertical axis.

21. The self-righting portable urinal container of claim 18, wherein said round open top comprises a diameter equal to 1.25 inches.

22. The self-righting portable urinal container of claim 18, wherein said round open top comprises a diameter equal to 1.50 inches.

23. The self-righting portable urinal container of claim 18, wherein said inner space of said housing comprises a volume of at least 90 fluid ounces.

24. The self-righting portable urinal container of claim 18, wherein said round open top comprises a diameter equal to 2.25 inches.

25. The self-righting portable urinal container of claim 18, wherein said round open top comprises a diameter equal to 2.50 inches.

26. A self-righting portable urinal container, comprising:
a housing defining an inner space, said housing comprising:
a flat bottom;
a continuous outer wall extending upwardly from said flat bottom, said continuous outer wall comprising at least one transparent portion adapted for visualization of a level of urine received into and contained within said housing;
an internally threaded neck configured to form an offset with said extended continuous outer wall, said internally threaded neck sized and configured to receive a penis of a user, said internally threaded neck comprising:
a first neck portion diagonally extending from said continuous outer wall; and
a second neck portion extended upwardly from said first neck portion;
a semispherical drip lip surrounding at least a portion of the internally threaded neck, said semispherical drip lip forming a urinal receptacle.

27. The self-righting portable urinal container of claim 26, further comprising a screw top comprising a top handle and a threaded bottom, said threaded bottom comprising a seal, said threaded bottom removably connected to said internally threaded neck.

28. The self-righting portable urinal container of claim 26, further comprising a retainer cord having a proximal end opposite a distal end, the proximal end fixed to a bottom surface of the screw top, the distal end attached perpendicular to an elongated retention rod, said elongated retention rod disposed in the inner space of the housing, said elongated retention rod having axial length that is greater in length than a diameter of the round open top.

29. The self-righting portable urinal container of claim 26, further comprising at least a first loop handle fixed to a first outer portion of the continuous wall, wherein said at least first loop handle is positioned on an angle that departs from a vertical axis of said housing.

30. The self-righting portable urinal container of claim 29, further comprising at least a second loop handle fixed to a second outer portion of the continuous outer wall, wherein said second outer portion is disposed on an opposite side of the housing than the first outer portion.
